(19) United States
(12) Patent Application Publication
(10) Pub. No.: US 2006/0145100 A1
(43) Pub. Date: Jul. 6, 2006

(54) System and method for detecting an object on a moving web

(75) Inventor: John H. Sorebo, Appleton, WI (US)

Correspondence Address: SCHWEGMAN, LUNDBERG, WOESSNER & KLUTH, P.A., P.O. BOX 2938, MINNEAPOLIS, MN, 55402, US

(73) Assignee: Kimberly-Clark Worldwide, Inc.

(21) Appl. No.: 11/028,085

(22) Filed: Jan. 3, 2005

(51) Int. Cl. G01N 21/86; G01V 8/00

(52) U.S. Cl. 250/559.01

(57) ABSTRACT

The system includes a light source that emits light onto a web and objects that are on the web. The system further includes a lens that has a radial index of refraction gradient. The lens is positioned such that the lens only captures light above a nominal level when light from the light source is reflected by the objects and not the web. A sensor receives light from the lens and converts the light to a signal. The method includes directing light onto the objects and the web using a light source. The method further includes positioning a lens that has a radial index of refraction gradient relative to the web and the light source such that the lens only captures light above a nominal level when the light from the light source is reflected by the objects. The method further includes focusing the captured light on a sensor.

### FIELD OF THE INVENTION

The present invention relates to a system and method for detecting an object on a moving web, and in particular to a system and method that use gradient-indexed optics to detect an object on a moving web.

### BACKGROUND OF THE INVENTION

A web is a flexible piece of material that has a width and thickness which are significantly smaller than the length of the web. Webs are used in many manufacturing processes to produce products efficiently (e.g., tissue, sheet metal, and films).

Most webs are conveyed at high speeds in order to produce high volumes of products. When a web is moving at high speeds it is important to make sure the web, and any objects that are on the web, are properly aligned or there may manufacturing problems. Some example manufacturing problems include slitting a product to the wrong width, spraying adhesive off the edges of the web, or failing to make a product to its targeted dimensions (among other problems).

The alignment of any objects on a web is typically determined by detecting the location of the objects that are on the web. As an example, the objects on the web may be located relative to the edges of the web and/or relative to a fixed reference point.

There are a variety of sensors that are available for detecting the position of objects on a web. Many of the sensors receive light that has been transmitted across a gap that is partially obstructed by the objects on the web. The sensors typically include a spherical or cylindrical lens that focuses light onto a light detector. The light detector produces a signal (e.g., an analog voltage) which represents the intensity of the light that is detected by the sensor.

The signal is typically sent via circuitry to a processor that is part of a control. The control then directs an adjustment mechanism to change the position of the web and/or the objects on the web based on instructions that are received from the processor.

One of the drawbacks with sensors which include cylindrical or spherical lenses is that the cylindrical or spherical lenses require a relatively large focal distance in order to properly focus light onto the light detector. This relatively large focal distance often makes it difficult to place the sensors in confined areas.

Another drawback with these types of sensors relates to establishing a field of view for the sensor because it is often necessary to zoom in on to a small detection area in order to get sufficient pixel resolution for the light detector within the sensor. Therefore, many sensors are limited to applications where the position of the web and/or the objects on the web does not vary position by more than a certain amount.

These types of sensors are also limited in their ability to detect objects on a moving web, especially when the objects and the web are similar colors and/or opacities. As an example, the consumer nondurable and medical products industries often use webs that are formed of nonwoven materials. Some of the objects that are placed on the nonwoven webs may be similarly formed of nonwoven materials or of materials that are similar in transparency and color to the nonwoven webs. Most sensing systems are not sophisticated enough to adequately sense such objects on these types of webs.

### SUMMARY OF THE INVENTION

The present invention relates to a system and method for detecting an object on a moving web. The system and method focus captured light onto sensors using gradient-indexed optics. The focal distance of the gradient-indexed optics may be relatively small such that the sensors are more readily placed in confined areas. The system and method may also make it easier to monitor the location of objects that are on a moving web, especially when the objects and the web are similar materials.

In one aspect, the system for detecting objects on a moving web includes a light source that emits light onto the web and the objects on the web. The system further includes a lens that has a radial index of refraction gradient. The lens is positioned relative to the light source and the web such that the lens only captures light above a nominal level when the light from the light source is reflected by the objects and not the moving web. The system further includes a sensor that receives light from the lens and converts the light to a signal.

In some embodiments, the system further includes a controller that receives the signal from the sensor and adjusts the position of the objects on the moving web based on the signal from the sensor. The signal may represent a shape and/or a position of the objects on the moving web.

In another aspect, the method of detecting objects on a moving web includes directing light onto the objects and the moving web using a light source. The method further includes positioning a lens that has a radial index of refraction gradient relative to the moving web and the light source. The lens is positioned such that the lens only captures light above a nominal level when the light from the light source is reflected by the objects and not the continuously moving web. The method further includes focusing the captured light on a sensor using the lens.

In some embodiments, the method further includes transmitting the signal to a controller and adjusting the position of the objects on the moving web using the controller. It should be noted that positioning a lens relative to the light source and the moving web may include positioning the lens and the light source on a same side of the moving web.

The purposes and features of the present invention will be set forth in the description that follows. Additional features of the invention may be realized and attained by the product and processes particularly pointed out in the written description and claims hereof, as well as from the appended drawings.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the invention.

### BRIEF DESCRIPTION OF THE DRAWINGS

The present invention will be more fully understood and further advantages will become apparent when reference is made to the following detailed description of the invention and the accompanying drawings. The drawings are merely representative and are not intended to limit the scope of the claims. Like parts depicted in the drawings are referred to by the same reference numerals.

FIG. 1 is a schematic perspective view illustrating an example system and method for detecting an object on a moving web where light is being reflected from the object into a lens.

FIG. 2 is a schematic side view illustrating example light paths traveling through a spherical lens.

FIG. 3 is a schematic side view illustrating example light paths traveling through an example gradient-indexed lens that may be used in the system of FIG. 1.

FIG. 4 is a schematic perspective view illustrating an example gradient-indexed lens array that may be used in the system shown in FIG. 1.

FIG. 5 is a schematic perspective view of the system shown FIG. 1 where light is not being reflected from the web into the lens.

### DETAILED DESCRIPTION OF THE INVENTION

The present invention relates to a system and method for detecting objects on a moving web. The system and method are well suited for detecting objects on a web when physical space limitations are such that other systems and methods cannot be used effectively.

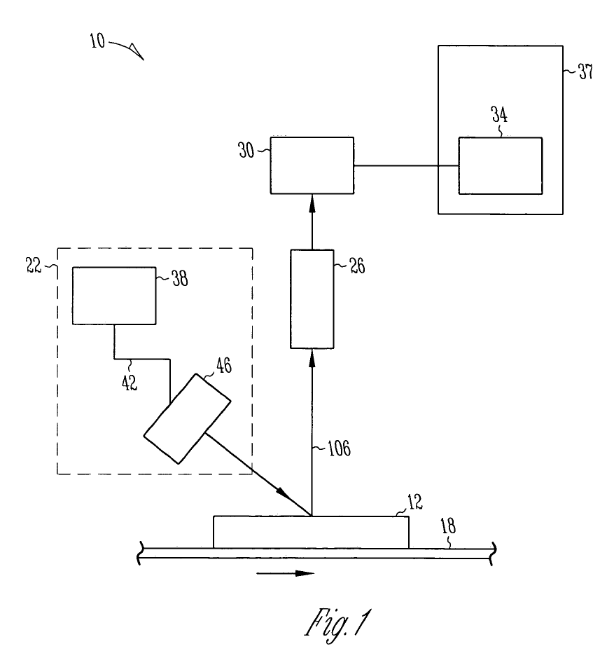

FIG. 1 shows a system 10 which may be used to detect an object 12 that is on a moving web 18. The system 10 includes a light source 22, a lens 26 and a sensor 30. Although only one object 12 is shown on web 18 in FIG. 1, the system 10 may be used to detect any number of objects 12 on the web 18. It should be noted that the objects 12 may be arranged on the web 18 in any orientation or spacing.

The light source 22 may include an illuminator 38 that is connected through a fiber optic cable 42 to a fiber optic light line 46. The light that is generated by the illuminator 38 is transmitted through the fiber optic cable 42 to the fiber optic light line 46. The fiber optic light line 46 is positioned adjacent to the web 18 such that the light source 22 emits light onto the web 18 and the objects 12 which are on the web 18.

It should be noted that other types of light sources 22 may be used in the system 10. Some example light sources include halogen bulbs, LED arrays, laser line generators and high-frequency fluorescent lighting systems (among other suitable sources of light).

The light from the light source 22 may be either coherent light or incoherent light depending in part on the application where the system 10 is to be used. As used herein, light refers to visible light, infrared light and ultraviolet light. In embodiments where the light source 22 emits ultraviolet light, the web 18 and/or the object 12 on the web 18 may include an optical brightener that fluoresces under ultraviolet light.

The lens 26 may be a gradient-indexed lens 26 which focuses light that has been captured after being reflected by the object 18. A gradient-indexed lens differs from a spherical or cylindrical lens in the manner in which it refracts light.

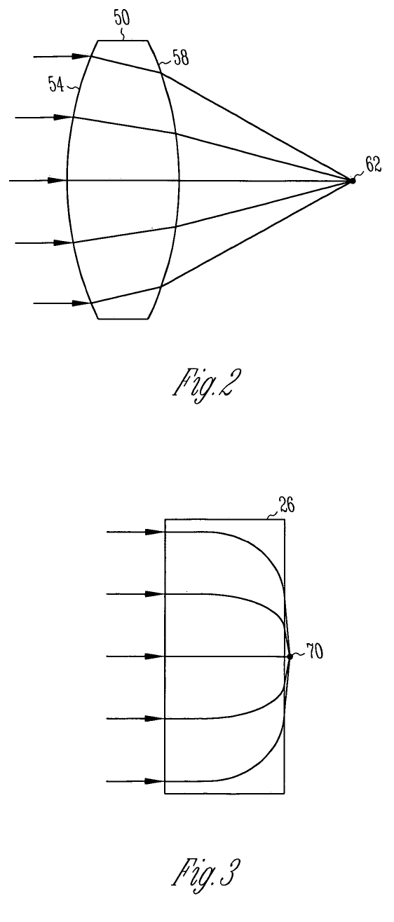

As illustrated in FIG. 2, a spherical lens 50 can refract light only at its surfaces 54, 58 (i.e., the air-glass interface). The shape, smoothness and material properties of the lens 50 may be controlled so that light can be focused at a given point 62.

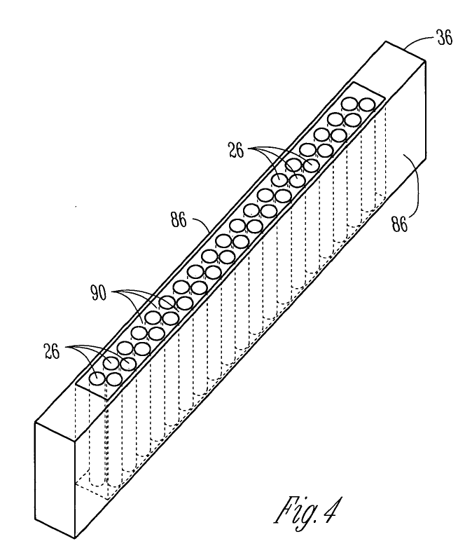

FIG. 3 shows an example lens 26 that has a radial index of refraction gradient (i.e., the index of refraction varies gradually within the lens). Since light refracts continuously throughout the gradient-indexed lens 26, the lens 26 focuses light on a point 70 that is much closer to the lens 26 when compared to spherical lens 50. Therefore, lenses that are similar to gradient-indexed lens 26 are well suited for use in applications where space is an issue.

In some embodiments, the gradient-indexed lens 26 may between A mm and B mm from the objects 12 on the moving web 18 and/or between X mm and Y mm from the moving web 18. In addition, the fiber optic light line 46 portion of the light source 22 may between C mm and D mm from the objects 12 on the moving web 18 and/or between Q mm and R mm from the moving web 18.

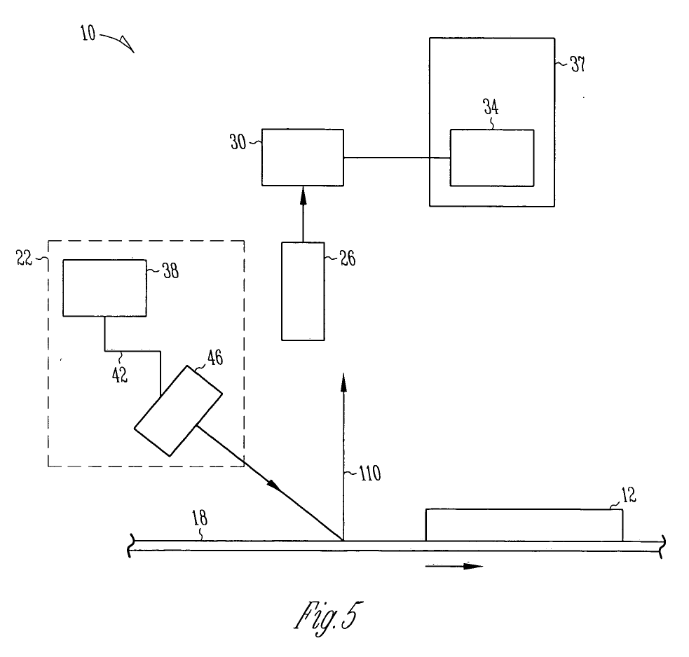

There are some embodiments where the lens 26 may be part of a plurality of gradient-indexed lenses 26 that form a gradient-indexed lens array. An example gradient-indexed lens array 36 is shown in FIG. 4. The lenses 26 in this gradient-indexed lens array 36 are precisely aligned between reinforced plates 86. The interstices 90 between the lenses 26 in the lens array 36 are filled with material to prevent crosstalk between the lenses 26 as well as to protect the individual lenses 26.

The gradient-indexed lens array 36 may be a SELFOC-brand gradient-indexed lens array, Model No. SLA20B1466602A4, made by NSG America, Inc., although any suitable gradient-indexed lens array may be used. It should be noted the lens array 36 is not limited to configurations that include one or two rows of gradient-indexed lenses 26. In addition, the number of gradient-indexed lenses 26 within each row may vary depending on the application where the system is to be used.

The sensor 30 is positioned adjacent to the lens 26 to receive light that is captured by the lens 26. The sensor 30 may include a light detector that converts the captured light into an electrical signal.

The sensor 30 may be a charge-coupled device (CCD) sensor, a complementary metal-oxide semiconductor (CMOS) sensor or any other suitable sensor. One example sensor 30 that may be used in the system 10 is a TAOS-brand CMOS sensor, Model No. TSL1406, although any compatible sensor may be used.

In some embodiments, the system 10 may further include a processor 34. The processor 34 may receive the signals from the sensor 30 and then determine the location of the objects 12 relative to the web 18 and/or a fixed reference point based on the signals. The processor 34 may be part of a control 37 that directs one or more adjustment mechanisms (not shown) to adjust the position of the web 18 and/or the objects 12 on the web 18.

Some example processors 34 that may be used in the system 10 are a TEXAS INSTRUMENTS digital signal processor, Model No. TMS320C5510, and a XILINX field programmable gate array, Part No. XCV50E, although any compatible processors may be used. The processor 34 may be integrated into the sensor 30 or implemented using hardware, software, firmware, or a combination thereof, as may be known to one skilled in the art.

During operation of the system 10, the illuminator 38 generates light that is passed through the fiber optic cable 42 to the fiber optic light line 46. The fiber optic light line 46 then emits light toward the web 18 and the objects 12 that are on the web 18.

The web 18 and the objects 12 reflect some of the light from the light source 22. The lens 26 is positioned relative to the web 18, the light source 22 and the objects 12 such that the only time light enters the lens 26 above a nominal level is when the light is reflected from the objects 12 on the web 18 (see arrow 106). Compare FIG. 1 with FIG. 5 which shows that the light which is reflected from the web 18 (see arrow 110) does not get directed toward the sensor 30.

Since the only time that the gradient-indexed lens 26 captures light above a nominal level is when the light is reflected from the objects 12 on the web 18, the sensor 30 is able to generate signals that establish the position of the objects 12 on the web 18. It should be noted that other light may enter the lens 26, but these light levels will be minimal compared to the light levels that enter the lens 26 when the objects 12 are positioned to reflect light from the light source 22 into the gradient-indexed lens 26. In addition, the lens 26 may have a limited acceptance angle such that the lens 26 filters out much of the unwanted light that would otherwise be focused onto the sensor 30 by the gradient-indexed lens 26.

In some embodiments, the light may be reflected into the lens 26 by fibers that form part of the objects 12. The level of light that gets reflected by the fibers which form the objects 12 will depend in part on the materials that are used for the fibers and how the fibers are formed.

It should be noted that other embodiments are contemplated where the light source 22 and the lens 26 are positioned on opposing sides of the web 18. As an example, light may be reflected as it passes through just the objects 12, or the objects 12 in combination with the web 18, depending on the materials of the objects 12 and the web 18 and the arrangement of the objects 12 on the web 18. The configuration of the system 10 for a given application will be determined in part by the space that is available to install the system 10.

In some embodiments, the processor 34 may receive the signals from the sensor 30 and calculate the position of the objects 12 on the web 18 by using a cross correlation calculation as described in U.S. patent application Ser. No. 10/027,266, which is incorporated herein by reference. Based on the calculations that are performed by the processor 34, the control 37 transmits directions to one or more adjustment mechanisms to change the position of the objects 12 on the web 18 (if necessary).

The cross correlation calculations may need to be employed to obtain sub-pixel resolution for the sensor 30 while also filtering out spatial noise associated with opacity variations in the web 18 and the objects 12 on the web 18. Since the gradient-indexed lens 26 is able to provide a one-to-one ratio of the object 12 to a sensed image, there may be little or no scaling or calibration that is required in order to determine the location of the objects 12 on the web 18.

The controller 37 may perform a variety of actions based on the signals that are received from the sensor 30. Some example actions include (i) adjusting the position of the object 12; (ii) rejecting the object 12 if the object 12 is of insufficient quality; and/or (iii) controlling the operation of a sprayer or some other device (among other possible actions).

A method of detecting objects on a moving web will now be described with reference to FIGS. 1-5. The method includes directing light onto a moving web 18 and one or more objects 12 that are on the moving web 18 by using a light source 22. The method further includes positioning a lens 26 that has a radial index of refraction gradient relative to the moving web and the light source 22. The lens 26 is positioned such that the only time the lens 26 captures light above a nominal level is when light from the light source 22 is reflected by the objects 12 and not the continuously moving web 18 into the lens 26 (compare FIGS. 1 and 5).

The method further includes focusing the captured light on a sensor 30 using the lens 26. The method may further include converting the focused light to a signal using the sensor 30. In some embodiments, converting the focused light to a signal using the sensor 30 may include determining a shape of the objects 12 and/or determining a position of the objects 12 on the web 18.

The method may further include transmitting the signal to a controller 37 and adjusting the position (or some other quality) of the objects 12 on the moving web 18 using the controller 37. The controller 37 may utilize a processor 34 that is similar to any of processors 34 described above.

It should be noted that positioning the lens 26 relative to the light source 22 and the moving web 18 may include positioning a gradient-indexed lens array (see, e.g., lens array 36 in FIG. 4) relative to the light source 22 and the moving web 18. In addition, positioning the lens 26 relative to the light source 22 and the moving web 18 may include positioning the lens 26 and the light source 22 on a same side of the moving web 18.

In some embodiments, positioning the lens 26 relative to the light source 22 and the moving web 18 may include positioning the lens 26 between A mm and B mm from the objects 12 on the moving web 18 and/or between X mm and Y mm from the web 18. The method may further include positioning the light source 22 between C mm and D mm from the objects 12 on the web 18 and/or between Q mm and R mm from the web 18.

Depending on the application where the method is to be used, focusing the captured light on a sensor 30 may include focusing the captured light on a CMOS image sensor or a CCD image sensor. In addition, directing light onto the objects 12 and the moving web 18 may include directing light onto foodstuffs or objects that are components of absorbent articles (among other objects).

The systems 10 and methods described herein may provide improved accuracy in the detection of objects 12 on a web 18. The systems 10 and methods may be used to determine the shape, position, reflectivity, or other quality of the objects 12 that are on the web 18. The object 12 to sensor 30 dimensions may be relatively small such that the system 10 may be positioned in more confined areas than would otherwise be possible.

It should be noted that the systems 10 and methods described herein may be applied to virtually any situation that requires machine vision. The dimensions and positions of the lenses, sensors and light sources will be determined in part based on the application where the systems 10 and methods are to be used.

The systems 10 and methods described herein may be especially effective at determining the location of objects 12 on a web 18 when the objects 12 and the web 18 are similar colors, opacities and/or materials. As an example, a web of spunbond material may be overlaid with discrete absorbent pads. The system 10 and method may be adapted to determine where a particular pad begins and ends and/or whether the pad is correctly aligned. It should be noted the object 12 does not necessarily have to add thickness to the web 18 but may simply be formed of a different material than the rest of the web 18 as long as the lens 26 only captures light above a nominal level when the light is reflected by the objects 12 and not the web 18.

Some of the example applications that may use the systems and methods described herein include measuring gaps between materials, glass manufacturing and missing parts detection. In addition, the systems and methods may be used to determine the position, presence, absence, shape, doneness, coverage, etc. of objects on a conveyor system.

As an example, cookies or other foodstuffs may be placed on a conveyor (i.e. web). The systems and methods may be used to determine one or more properties of the cookies as they travel along the conveyor. Examples of such properties include (i) whether each cookie has sufficient roundness; (ii) the position of each cookie; and/or (iii) the doneness of each cookie as they are baked (based on the shape/size of the cookies at a particular time). Cookies of insufficient quality can be rejected.

It should be noted other types of radiation may be used in place of light in the systems and methods described herein. Some example forms of radiation include microwaves, x-rays, gamma, beta and neutron radiation as long as suitable lenses and sensing devices are utilized.

While the invention has been described in detail with respect to the specific aspects thereof, it will be appreciated that those skilled in the art, upon attaining an understanding of the foregoing, may readily conceive of alterations to, variations of, and equivalents to these aspects. Accordingly, the scope of the present invention should be assessed as that of the appended claims and any equivalents thereto.

1. A system for detecting objects on a moving web, the system comprising:
a light source that emits light onto the web and the objects on the web;
a lens having a radial index of refraction gradient, the lens being positioned relative to the light source and the web such that the lens only captures light above a nominal level when the light is reflected by the objects and not the web; and
a sensor that receives light from the lens and converts the light to a signal.

2. The system of claim 1, further comprising a controller that receives the signal from the sensor.

3. The system of claim 2, wherein the controller adjusts the position of the objects based on the signal from the sensor.

4. The system of claim 1, wherein the signal represents a shape of the objects on the moving web.

5. The system of claim 1, wherein the signal represents a position of the objects on the moving web.

6. The system of claim 1, wherein the lens is a gradient-indexed lens array.

7. The system of claim 1, wherein the lens is a two-dimensional gradient-indexed lens array.

8. The system of claim 1, wherein the sensor is a CMOS image sensor.

9. The system of claim 1, wherein the sensor is a CCD image sensor.

10. The system of claim 1, wherein the lens and the light source are positioned on a same side of the moving web.

11. The system of claim 1, wherein the light source produces visible light.

12. The system of claim 1, wherein the light source produces infrared light.

13. The system of claim 1, wherein the light source produces ultraviolet light.

14. The system of claim 1, wherein the object includes fibers such that the light that is captured by the lens is light that is reflected by the fibers.

15. The system of claim 1, wherein the lens is between 4 mm and 50 mm from the objects on the moving web.

16. The system of claim 1, wherein the light source is between 5 mm and 100 mm from the objects on the moving web.

17. The system of claim 16, wherein the light source is between 5 mm and 100 mm from the moving web.

18. The system of claim 15, wherein the lens is between 4 mm and 50 mm from the moving web.

19. A method of detecting objects on a moving web, the method comprising:
directing light onto the objects and the moving web using a light source;
positioning a lens having a radial index of refraction gradient relative to the moving web and the light source such that the lens only captures light above a nominal level when the light is reflected by the objects and not the continuously moving web; and
focusing the captured light on a sensor using the lens.

20. The method of claim 19, further comprising converting the focused light to a signal using the sensor.

21. The method of claim 20, further comprising transmitting the signal to a controller.

22. The method of claim 21, further comprising adjusting the position of the objects using the controller.

23. The method of claim 20, wherein converting the focused light to a signal using the sensor includes determining a shape of the objects.

24. The method of claim 20, wherein converting the focused light to a signal using the sensor includes determining a position of the objects.

25. The method of claim 19, wherein positioning a lens having a radial index of refraction gradient relative to the light source and the moving web includes positioning a gradient-indexed lens array relative to the light source and the moving web.

26. The method of claim 19, wherein focusing the captured light on a sensor includes focusing the captured light on a CMOS image sensor.

27. The method of claim 19, wherein focusing the captured light on a sensor includes focusing the captured light on a CCD image sensor.

28. The method of claim 19, wherein positioning a lens relative to the light source and the moving web includes positioning the lens and the light source on a same side of the moving web.

29. The method of claim 19, wherein directing light onto the objects and the moving web includes directing light onto objects that are components of absorbent articles.

30. The method of claim 19, wherein directing light onto the objects and the moving web includes directing light onto foodstuffs.

31. The method of claim 19, wherein positioning a lens relative to the light source and the web includes positioning a lens between 4 mm and 50 mm from the objects on the web.

32. The method of claim 31, positioning a lens relative to the light source and the web includes positioning a lens between 4 mm and 50 mm from the web.

33. The method of claim 19, further comprising positioning the light source between 5 mm and 100 mm from the objects on the web.

34. The method of claim 33, further comprising positioning the light source between 5 mm and 100 mm from the web.
